(19) United States
(12) Patent Application Publication
(10) Pub. No.: US 2015/0339838 A1
(43) Pub. Date: Nov. 26, 2015

(54) IMAGE MASK PROVIDING A MACHINE-READABLE DATA MATRIX CODE

(71) Applicant: EYECONIT LTD., Herzliya (IL)

(72) Inventors: Itamar FRIEDMAN, iSRALEL (IL); Nevo ALVA, Karmey Josef (IL); Uriei PELED, Kibbutz Ramat Yohanan (IL)

(73) Assignee: EYECONIT LTD., Herzliya (IL)

(21) Appl. No.: 14/410,322

(22) PCT Filed: Jun. 24, 2013
(86) PCT No.: PCT/IL2013/050535

§ 371 Date: Dec. 22, 2014

Related U.S. Application Data
(60) Provisional application No. 61/664,198, filed on Jun. 26, 2012.

(51) Int. Cl. G06T 11/60; G06K 7/14; G06K 19/06

(52) U.S. Cl. CPC G06T 11/60; G06K 19/06103; G06K 7/1417; G06K 7/1443; G06K 7/1495

(57) ABSTRACT

A method, comprising: obtaining a message; initializing a plurality of digital image elements based on a template of a machine-readable matrix code, wherein each digital image element is associated with one or more machine-readable matrix code cells; and computing a color and a translucency property for each one of the plurality of digital image elements based on the message and based on a machine-readable matrix code specification, wherein at least two cells having an identical decode input value are associated with respective digital image elements, and wherein the digital image elements with which each one of the at least two cells is associated have a different color and/or translucency property relative to the color and/or translucency property of the digital image elements that are associated with the other cells from said at least two cells; and generating a machine-readable matrix code mask using the plurality of digital image elements.

### FIELD OF THE INVENTION

The present invention is in the field of optical machine-readable data matrix codes.

### BACKGROUND

One common machine-readable data matrix code is the Quick Response (“QR”) Code. QR Code is a registered trademark of Denso Wave of Chita-gun Aichi, Japan.

A QR Code consists of an array of black cells (square dark dots) and white cells (square light dots) arranged in a square pattern on a white background. A negative option is valid also, where the background is black. The information encoded can be made up of four standardized kinds (“modes”) of data (numeric, alphanumeric, byte/binary, Kanji). Supported extensions allow various other kinds of data. A QR code includes three distinctive squares, known as finder patterns, which can be used for normalizing image size, orientation, and angle of viewing. Other functional patterns, such as the alignment and timing patterns can also be used and can further contribute to the decoding process.

Another common machine-readable data matrix code is the EZcode created by ETH of Zurich, Switzerland, and was exclusively licensed to Scanbuy of New York, N.Y., in 2006.

U.S. Pat. No. 8,144,922 to Kawabe et al discloses a two-dimensional code with a logo, wherein a two-dimensional code that represents information by means of a cell dot distribution pattern formed by having a plurality of cells colored and a logo mark visually representing characters are superimposed. In a preferred embodiment, at least a part of the cell dot color area is smaller than the cell area while the two-dimensional code that represents the information by means of the cell dot distribution pattern that color codes the cells and the logo mark that visually represents the character are superimposed.

US Patent Publication 2009/0057420 to Onoda et al discloses a clear two-dimensional code which can be merged with an image without giving a user a feeling of disorder when the clear two-dimensional code is attached to the image and in which a readable situation and the like can be arbitrarily set; an article having the clear two-dimensional code attached thereto; a method for printing the two-dimensional code; and a method for displaying the two-dimensional code. Base cells and data cells are arranged in a matrix, and either the base cells or the data cells are clear. The clear two-dimensional code can be read only when a color shown on the clear cells, consisting of either the base cells or the data cells, and a color shown on non-clear cells, consisting of either the base cells or the data cells, have a contrast which can be read by a code recognition apparatus.

### SUMMARY OF THE INVENTION

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on a computer readable medium, including on a tangible computer readable medium, and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, a presently disclosed component(s) can be embodied in operational data or operational data can be used by a presently disclosed component(s). By way of example, such operational data can be stored on a tangible computer readable medium. The operational data can be a single data set, or it can be an aggregation of data stored at different locations, on different network nodes or on different storage devices.

The method or apparatus according to the subject matter of the present application can have features of different aspects described above or below, or their equivalents, in any combination thereof, which can also be combined with any feature or features of the method or apparatus described in the Detailed Description presented below, or their equivalents.

According to an aspect of the presently disclosed subject matter, there is provided a method of generating a machine-readable matrix code image mask. According to examples of the presently disclosed subject matter, the method of generating a machine-readable matrix code image mask can include: obtaining a message; initializing a plurality of digital image elements based on a template of a machine-readable matrix code, wherein each digital image element is associated with one or more machine-readable matrix code cells; and computing a color property and a translucency property for each one of the plurality of digital image elements based on the message and based on a machine-readable matrix code specification, wherein at least two cells having an identical decode input value are associated with respective digital image elements, and wherein the digital image elements with which each one of the at least two cells is associated have a different color property and/or a different translucency property relative to the color property and/or the translucency property of the digital image elements that are associated with the other cells from said at least two cells; and generating a machine-readable matrix code mask using the plurality of digital image elements.

According to examples of the presently disclosed subject matter, the method can further include: superimposing the machine-readable matrix code image mask on a base image, giving rise to a machine-readable matrix code overlay image encoding the message.

According to examples of the presently disclosed subject matter, the message can be in a form of a machine-readable matrix code or in a form of a machine-readable matrix code mask.

According to examples of the presently disclosed subject matter, the plurality of image elements can be pixels. Further by way of example, the plurality of image elements can be vectors.

According to examples of the presently disclosed subject matter, computing can include computing also a shape property for a plurality of digital image elements.

According to examples of the presently disclosed subject matter, the machine-readable matrix code image mask can be provided as a layer in a multi-layered video stream.

By way of example, computing a color property and a translucency property can include: computing a color property and/or a translucency property for each one of the plurality of digital image elements based on the decode input value of a machine-readable matrix code cell with which the digital image element is associated and based on a visual transformation effect resulting from superimposing the digital image element on a base image and taking into account a tolerance provided in a machine-readable matrix code specification.

According to examples of the presently disclosed subject matter, the method can include adapting a color property and/or a translucency property of a digital image element based on decode input values of one or more other digital image elements.

According to examples of the presently disclosed subject matter, the method can include adapting a color property and/or a translucency property of a digital image element based on a visual transformation effect resulting from superimposing one or more other digital image elements over respective areas of a base image.

According to examples of the presently disclosed subject matter, the method can also include obtaining an input image and computing a color property and a translucency property can include: computing the color property and/or a translucency property for each one of the plurality of digital image elements based on a visual transformation effect resulting from superimposing the digital image elements on the input image and taking into account a visual similarity measure among the readable matrix code overlay image and the input image.

According to examples of the presently disclosed subject matter, the input image can be a video frame from a plurality of video frames, and wherein at least the computing and generating operations can be repeated for each video frame from the plurality of video frames.

According to examples of the presently disclosed subject matter, the input image can be a single image from a set of images which together are an animated image, and at least the computing and generating operations can be repeated for each image from the plurality of the images.

According to a further aspect of the presently disclosed subject matter, there is provided a machine-readable matrix code mask encoding a message. According to examples of the presently disclosed subject matter, the machine-readable matrix code mask encoding a message can include: a plurality of digital image elements associated with function patterns of a machine-readable matrix code; and a plurality of digital image elements associated with code-words cells of machine-readable matrix code, wherein the decode input values for the cells are based on the message and based on a machine-readable matrix code specification, and wherein each one of the plurality of digital image elements has a color property and a translucency property, and at least two cells having the same decode input values are associated with digital image elements having different color property and/or translucency property, such that when the machine-readable matrix code mask is superimposed on an image, a machine-readable matrix code image is generated.

According to examples of the presently disclosed subject matter, each one of the plurality of digital image elements can have a shape. Further by way of example, the plurality of digital image elements that are associated with code-word cells in the machine-readable matrix code image can include one or more groups of digital image elements, and each group of digital image elements can include two or more digital image elements, and each one of the two or more digital image elements in a group of digital image elements can have a color property and/or a translucency property which provides, together with other digital image elements in the group, a decode input value for a cell with which the group of image elements is associated, such that the decode input value for the cell is compatible with the machine-readable matrix code specification.

According to examples of the presently disclosed subject matter, the color property and/or a translucency property of each digital image element in a group of digital image elements can be computed, taking into account a visual transformation effect resulting from superimposing the digital image elements in the group of digital image elements on a base image, and taking into account a tolerance provided in the machine-readable matrix code specification.

According to yet a further aspect of the presently disclosed subject matter, there is provided an apparatus for generating a machine-readable matrix code image mask. According to examples of the presently disclosed subject matter, the apparatus for generating a machine-readable matrix code image mask can include a memory unit, a configurator and an image processing. The memory unit can be adapted to store a message. The configurator can be adapted to initialize a plurality of digital image elements based on a template of a machine-readable matrix code, wherein each digital image element can be associated with one or more machine-readable matrix code cells. The image processing module can be configured to compute a color property and a translucency property for each one of the plurality of digital image elements based on the message and based on a machine-readable matrix code specification, such that for at least two cells having an identical decode input value, the digital image elements with which each one of the at least two cells is associated have a different color property and/or a different translucency property relative to the color property and/or the translucency property of the digital image elements that are associated with the other cells from said at least two cells, and wherein the image processing module can be configured to generate a machine-readable matrix code mask using the plurality of digital image elements.

According to examples of the presently disclosed subject matter, the image processing module can be further configured to superimpose the machine-readable matrix code image mask on a base image, giving rise to a machine-readable matrix code overlay image encoding the message.

According to examples of the presently disclosed subject matter, the image processing module can be further configured to compute a shape in addition to computing a color property and a translucency property for each one of the plurality of digital image elements based on the message and based on a machine-readable matrix code specification.

According to examples of the presently disclosed subject matter, the image processing module can be configured to compute a color property and/or a translucency property for each one of the plurality of digital image elements based on the decode input value of a machine-readable matrix code cell with which the digital image element is associated and based on a visual transformation effect resulting from superimposing the digital image element on a base image and taking into account a tolerance provided in a machine-readable matrix code specification.

According to examples of the presently disclosed subject matter, the image processing module can be configured to adapt a color property and/or a translucency property of a digital image element based on decode input values of one or more other digital image elements.

According to examples of the presently disclosed subject matter, the image processing module can be configured to adapt a color property and/or a translucency property of a digital image element based on a visual transformation effect resulting from superimposing one or more other digital image elements over respective areas of a base image.

According to examples of the presently disclosed subject matter, the memory can be further configured to store an input image, and the image processing module can be configured to compute the color property and the translucency property for each one of the plurality of digital image elements based on a visual transformation effect resulting from superimposing the digital image elements over the input image and taking into account a visual similarity measure among the readable matrix code overlay image and the input image.

### BRIEF DESCRIPTION

For a better understanding of the invention, reference is made to the accompanying drawings and description, in which:

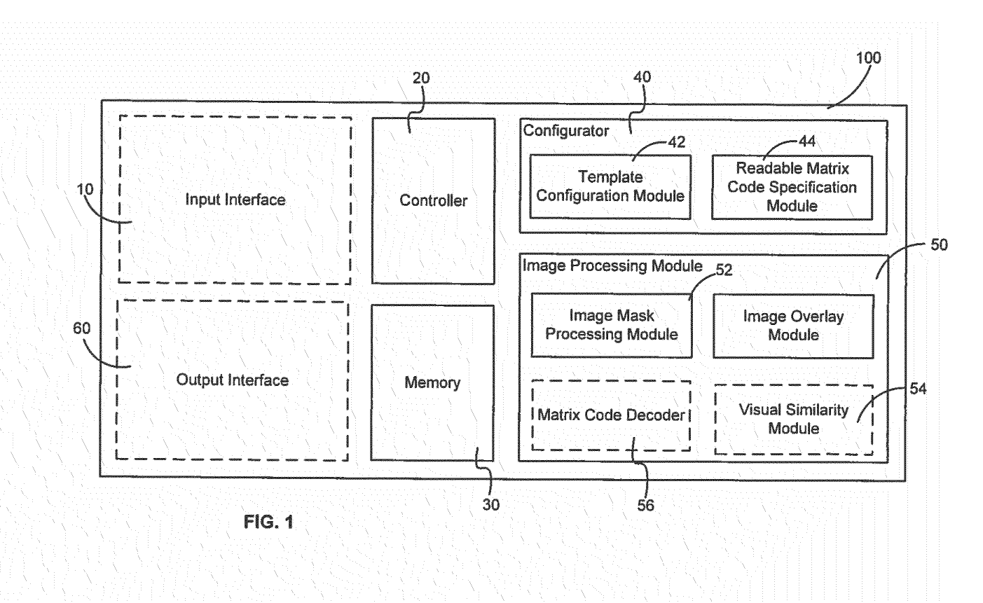

FIG. 1 illustrates a block diagram illustration of an apparatus that is capable of generating an image mask, according to examples of the presently disclosed subject matter;

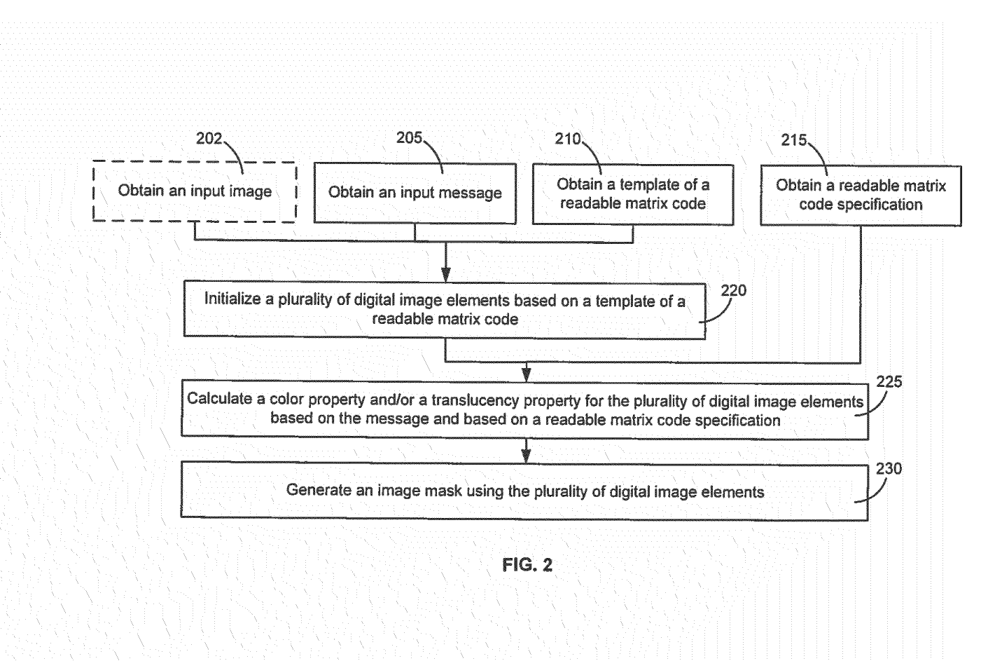

FIG. 2 illustrates a flowchart illustration of a method of generating an image mask, according to examples of the presently disclosed subject matter;

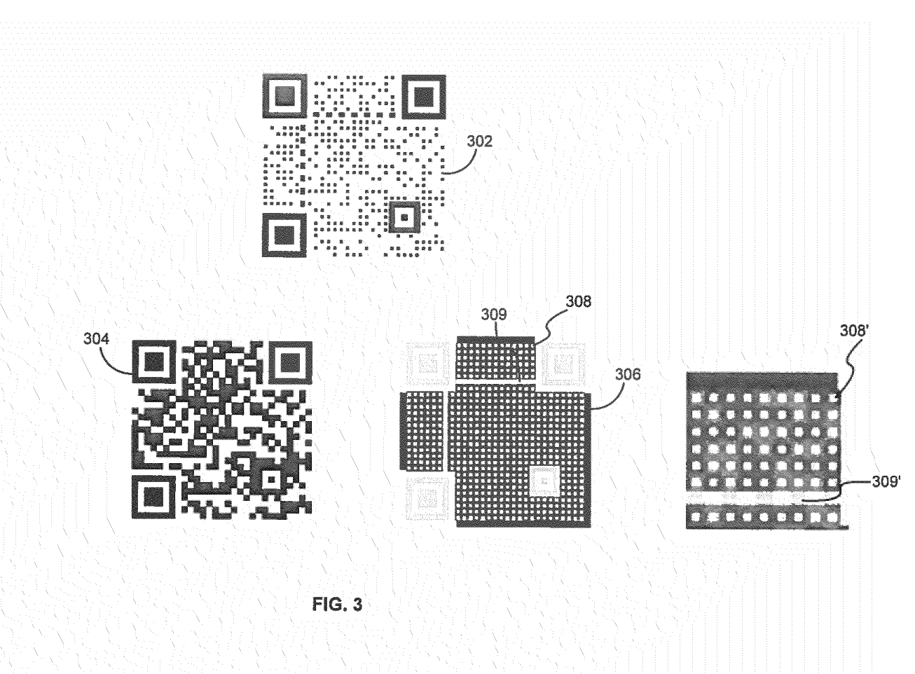

FIG. 3 illustrates an example of an image mask calculated according to examples of the presently disclosed subject matter;

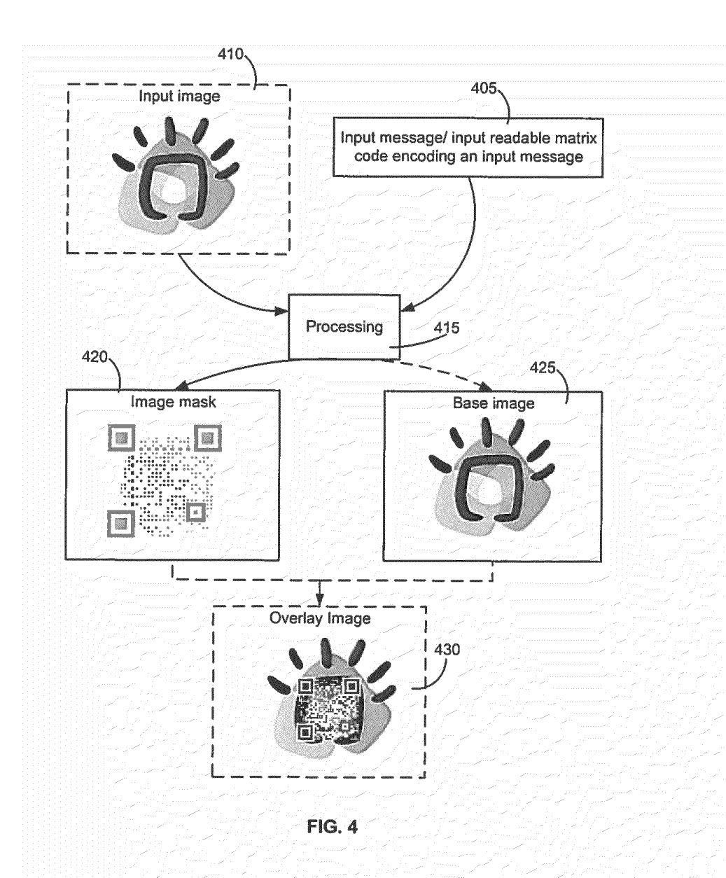

FIG. 4 is a graphical illustration of the Images and other data involved in a method of generating an image mask according to examples of the presently disclosed subject matter;

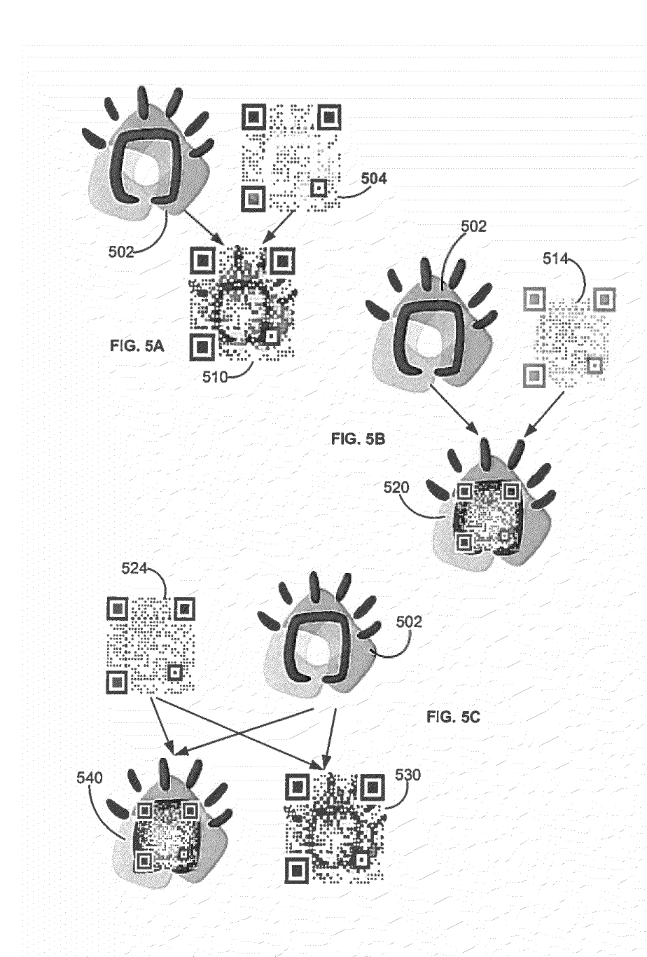

FIG. 5A illustrates a graphical illustration of an image mask, according to examples of the presently disclosed subject matter;

FIG. 5B illustrates an image mask, according to examples of the presently disclosed subject matter; and

FIG. 5C illustrates an image mask that is generated based on a generic image, according to examples of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the presently disclosed subject matter. However, it will be understood by those skilled in the art, that the presently disclosed subject matter may be practiced without some of these specific details. In other instances, well-known methods, procedures and components have not been described in detail so as not to obscure the presently disclosed subject matter.

Unless specifically stated otherwise, as apparent from the following discussions, it is appreciated that throughout the specification discussions various functional terms can refer to the action and/or process of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, transmission or display devices.

According to an aspect of the presently disclosed subject matter there is provided a method of generating a machine-readable matrix code mask encoding a message. Throughout the description and the claims, reference is made to the term “image mask”. The term image mask is known in the art of digital imaging, and the following definition is provided as a non-limiting example only for convenience purposes. Accordingly, interpretation of the term image mask in the claims, unless stated otherwise, is not limited to the definitions below and the term should be given its broadest reasonable interpretation. The term image mask as used herein relates to a two-dimensional image that includes: one or more color channels and a translucency channel (sometimes referred to as “alpha channel”). An image mask is sometimes also referred to as a transparent image or a translucent image. The one or more color channels and/or the translucency channel can be represented as matrices (e.g., of pixels) or by any other standard such as using vectors or a proprietary channel representation method.

According to examples of the presently disclosed subject matter, an image mask is comprised of a plurality of digital image elements. The term “digital image elements” is known in the art of digital imaging, and the following definition is provided as a non-limiting example only for convenience purposes. Accordingly, interpretation of the term digital image elements in the claims, unless stated otherwise, is not limited to the definitions below and the term should be given its broadest reasonable interpretation. The term digital image elements as used herein relates to sub-image or sub image-mask elements which have visual properties that can be adjusted to control the appearance of the respective digital image area. For example, a digital image element can have a color property which defines the color of the respective digital image area and/or a translucency property which defines the translucency of the respective digital image area. Non-limiting examples of types of a digital image element include a pixel and a vector. Another example of a visual property of a digital image element can be a shape property, which in some cases can be provided to define a shape of the digital image element.

Throughout the description and the claims, reference is made to the term “base image”. The term base image is known in the art of digital imaging, and the following definition is provided as a non-limiting example only for convenience purposes. Accordingly, interpretation of the term base image in the claims, unless stated otherwise, is not limited to the definitions below and the term should be given its broadest reasonable interpretation. The term base image as used herein relates to a two-dimensional image on which the image mask is superimposed.

In some examples of the presently disclosed subject matter, the base image is a specific base image, and the image mask can be generated taking into account one or more properties of the base image or of one or more parts of the base image. In another example, the image mask can be generated taking into account one or more properties of an overlay image or of parts thereof, resulting from superimposing an image mask on a specific base image.

In further examples of the presently disclosed subject matter, the base image is not a specific image (or is a non-specific image), e.g., the base image can be a generic representation of an image or of a variety of possible base images, and the image mask can be generated taking into account a respective range of possible properties of the generic or non-specific base image or of one or more parts of the base image. In yet another example the image mask can be generated taking into account one or more properties of an overlay image or of parts thereof, resulting from superimposing an image mask on a generic or non-specific base image. By way of example, the base image can be a completely white image.

Examples of the presently disclosed subject matter which relate to the generation of an image mask are described below.

Throughout the description and the claims, reference is made to the term “overlay image”. The term overlay image as used herein relates to a two-dimensional image resulting from superimposing an image mask that is generated according to examples of the presently disclosed subject matter, over a specific or over a generic base image. According to examples of the presently disclosed subject matter, and as will be further explained herein, the overlay image provides a digital representation of a machine-readable matrix code or a digital matrix code representation, and these terms are used interchangeably in the description and in the claims. Thus, in some cases, the term machine-readable matrix code overlay image is used herein interchangeably with the term overlay image, and vice-versa.

It should be appreciated that the image mask, the base image and the overlay image can be presented in various forms including, but not limited to: pixels on at least one digital visual display, vectors stored in a tangible computer readable storage medium which can be rendered to print parameters for configuring a digital printer to print an image, color frequencies stored in a tangible computer readable storage medium which can be rendered to pixels or other digital image elements for displaying a corresponding image on at least one digital visual display, etc. According to examples of the presently disclosed subject matter, the overlay image, in whatever form, represents a readable matrix code, and different areas in the overlay image represent individual cells or patterns of the readable matrix code. Accordingly, the overlay image or some part thereof enables an imager, scanner and/or decoder to convert the image (or the respective part of the image) to cells and modules of a matrix code in a manner to allow decoding of the overlay image according to a corresponding machine-readable matrix code specification.

Throughout the description and the claims, reference is made to the term “machine-readable matrix code”. The term machine-readable matrix code is known in the art of optical machine-readable coding, and the following definition is provided as a non-limiting example only for convenience purposes. Accordingly, interpretation of the term machine-readable matrix code in the claims, unless stated otherwise, is not limited to the definitions below and the term should be given its broadest reasonable interpretation. The term machine-readable matrix code as used herein relates to an optical machine-readable representation of data in the form of a two-dimensional pattern of symbols. Examples of known matrix code types include: QR-Code, EZcode and DataMatrix.

Different matrix code types are associated with different respective machine-readable matrix code specifications. The term “machine-readable matrix code specification” is known in the art of optical machine-readable coding, and the following definition is provided as a non-limiting example only for convenience purposes. Accordingly, interpretation of the term machine-readable matrix code specification in the claims, unless stated otherwise, is not limited to the definitions below and the term should be given its broadest reasonable interpretation. The term machine-readable matrix code specification as used herein relates to a framework of specifications which collectively define various aspects relating to the visual appearance of an object that has some code that is visually encoded on the object in the form of a visual matrix code. By way of example, a machine-readable matrix code specification can include some or all of the following: a general matrix specification, a basic cell specification, a function (such as finder) patterns specification, a code-words area specification, a free cells specification, a derived cells specification and a selected cells specification.

Based on a given machine-readable matrix code specification, a compatible decoder can be designed and operated to allow identification, scanning and decoding of visual objects that include compatible matrix code.

It should be noted that some matrix coding specifications include tolerances or variations and allow for the appearance of the cells and/or of the two-dimensional patterns which form the respective matrix code to have different appearances or to shift within a certain range without rendering the matrix code unreadable or non-compatible with the matrix code specification. For example, some types of machine-readable matrix code specifications can include: different coding modes, different coding masks, decoding masks, reflectance reversal, mirror imaging etc., and a message can be associated with different overlay images that provide different matrix codes representations, for example according to the different modes, coding masks, etc., and each of the different overlay images can be compatible with the machine-readable matrix code specification. It would be further appreciated the different overlay images which can be used as machine-readable matrix code representation for a given message can be associated with respective different image masks, and that the different image masks can be generated according to the tolerances or variations in the respective matrix code specification.

It would be appreciated that throughout the present disclosure and in the claims, the term “tolerance” encompasses also a negative tolerance which can be effective for limiting a certain range of values which is suggested or required for modules, cells or patterns that are part of a machine-readable matrix code.

Furthermore, it should be noted, that some scanners, imagers, readers and/or decoders allow certain tolerances and/or deviations from the machine-readable matrix code specification as will be further explained below.

Accordingly, in some examples of the presently disclosed subject matter, the term “machine-readable matrix code” can refer to a matrix code that is compatible with a respective machine-readable matrix code specification, and in further examples of the presently disclosed subject matter, the term “machine-readable matrix code representation” can relate to a representation of a matrix code (the overlay image) that is machine-readable according to a certain matrix code specification that is configured, adapted or adjusted in accordance with the specific characteristics of a given imager, scanner, reader or decoder (sometimes collectively referred to herein in a non-limiting manner as the “equipment”) or any combinations thereof, or even to a general characteristic of the equipment. In the latter case, the readability or eligibility of the matrix code representation is determined according to the ability, possibly the de-facto ability, of a certain decoding device or devices to decode a given matrix code representation that is generated based on a given machine-readable matrix code specification and the tolerances and/or deviations that are supported or corrected by the decoding device or devices.

For example, the QR-Code specification (used here as an example of a machine-readable matrix code specification) defines the color values of cells as dark and light. By way of example, a QR-Code scanner, that is a matrix code scanner that is configured to scan and decode matrix codes that are compatible with the QR-Code specification, can convert an image which includes dark and light colors which represent a matrix code to a set of dark and light pixels using a global threshold, and thus the colored image representing the matrix code provides a machine-readable matrix code. By way of example, the global threshold that is implemented by the QR-Scanner can be determined by taking a reflectance value midway between the maximum reflectance and minimum reflectance in the image. This means that according to examples of the presently disclosed subject matter, digital image elements or groups of digital image elements in an overlay image which represents a machine-readable matrix code, can have a range of color and/or shapes choices for areas which represent machine-readable matrix code cells for which the machine-readable matrix code specification suggests a light or a dark value. Further, this means that according to examples of the presently disclosed subject matter, digital image elements or groups of digital image elements in an image mask which are generated for being used to provide a machine-readable matrix code overlay image (in combination with a base image) can have, according to examples of the presently disclosed subject matter, a range of color and/or translucency choices or selected shapes for areas which correspond to machine-readable matrix code cells for which the machine-readable matrix code specification suggests a light or a dark value.

Throughout the description and in the claims reference is made to the term “shape” in the context of the digital image elements of an image mask. The image mask, according to examples of the presently disclosed subject matter, is computed in a manner to enable generation of an overlay image which provides a machine-readable matrix code, and possibly the computation of the image mask can take into account additional goals or criteria as will be further described below. Thus, when reference is made to the shape of a digital image element or of a group of digital image elements, what is meant is that certain properties of the digital image element or of members of a group of digital image elements are set such that the appearance of the digital image element or of the group of digital image element corresponds to a certain target shape which was computed for (although the shape can also be predefined) in the process of computing the image mask.

In this sense, according to examples of the presently disclosed subject matter, a matrix code can be considered to be a machine-readable matrix code, even when the colors and/or shapes of the digital image elements that are used in the matrix code or in the image which represents the matrix code are not explicitly, in and of themselves, compatible with the corresponding machine-readable matrix code specification, but are such that when read and processed by the reader/decoder the resulting color values of the matrix code cells are compatible with the machine-readable matrix code specification. It also means, that according to examples of the presently disclosed subject matter, an image mask can be considered to provide, together with a specific or a generic base image, a machine-readable matrix code overlay image, even when the color and/or translucency properties or shapes that are used in the image mask would result in a machine-readable matrix code overlay image in which the colors and/or the shapes of the digital image elements are not explicitly, in and of themselves, compatible with the corresponding machine-readable matrix code specification, but are such that when read and processed by the reader/decoder the resulting color values of the matrix code cells are compatible with the machine-readable matrix code specification.

In a simplified example, a light grey or semitransparent grey pixel in the image mask could be translated to a white cell after processing and decoding of an overlay image resulting from overlaying the image mask onto a base image. In another simplified example, a group of pixels in an image mask which associate with a machine-readable matrix code cell can have light and dark grey color (or any other grey/light colors) in a pattern which forms a circle within a square, and this group of pixels could be translated after processing and decoding of an overlay image that was generated using the image mask to a light or dark cell, e.g., according to the average of all the pixels which correspond to the machine-readable matrix code cell.

The freedom with regard to the color and/or translucency or shape choices of the digital image elements in the image mask (and also in the respective overlay image) can be based on the machine-readable matrix code specification, but additional processing can be applied to take advantage, inter-ala, of the tolerances, characteristics, configurations and/or capabilities of the decoders, scanners or imagers and software that is involved in the process of imaging processing and decoding the respective overlay image (or any other equipment that is used to process an image and decode a matrix code), such that the values that are calculated for the digital image elements of the image mask can be computed so as to provide, together with respective area of a specific or a generic base image, a machine-readable matrix code overlay image which meets a certain criterion. Further by way of example, the values that are calculated for the digital image elements of the image mask, taking advantage of the aforementioned machine-readable matrix code specific tolerances and/or the tolerances, characteristics, configurations and/or capabilities of the aforementioned equipment and software, can be computed so as to provide, together with a respective area of a specific or a generic base image, a machine-readable matrix code overlay image which provides a certain level (e.g., the highest possible) of visual perceptual similarity to respective areas of a reference image, while meeting, de-facto, following imaging, scanning, processing, decoding etc. requirements of the machine-readable matrix code specification. Further by way of example, the reference image can be the base image.

Thus, further by way of example, the QR-Code specification suggests that a reader apparatus reads and defines the colors of certain cells or areas of a QR-Code representation by sampling a group (e.g., a small group) of pixels around the center of each cell and comparing the sampled values to the global threshold. This means that in certain cells it is not necessary that all pixels will meet the conditions that are suggested or required by the machine-readable matrix code specification with respect to the global threshold, and the colors of the matrix code representation and shapes of the digital image elements which correspond to a machine-readable matrix code cell can be varied, such that through the imaging or processing of the captured image, the resulting areas which correspond to the machine-readable matrix cells are compatible with the QR-Code specification, and thus the matrix code representation is considered according to examples of the presently disclosed subject matter to be a machine-readable matrix code or in this particular example, a machine-readable QR-Code.

In some examples of the presently disclosed subject matter, the color and/or translucency properties and/or the shape of digital image elements of an image mask, can be computed taking into account the color and/or translucency properties and/or the shape of other digital image elements or areas of the image mask or of the base image. Still further by way of example the color and/or translucency properties and/or the shape of digital image elements of an image mask, can be computed taking into account the color and/or translucency properties and/or the shape of other digital image elements or areas of the image mask or of the base image, and further taking into account the global threshold defined in the machine-readable matrix code specification and/or which is implemented by the equipment, such that through the imaging or processing of the machine-readable matrix code overlay image, the resulting areas which correspond to the matrix code cells are compatible with the machine-readable matrix code specification, and thus the matrix code representation is considered according to examples of the presently disclosed subject matter to be a machine-readable matrix code or in this particular example, a machine-readable QR-Code.

In yet another example, the machine-readable matrix code can provide different tolerances for different cell types or module types. Examples of different cell types and module types are described below.

In still another example, the matrix code specification, e.g. QR-Code specification, can support an error correction feature. The matrix code representation, which is according to examples of the presently disclosed subject matter, the machine-readable matrix code overlay image, can include areas which correspond to error symbols, and each error correction symbol can be associated with one or more error correction cells, which together form the error correction symbol. The error correction symbols (and the error correction cells which constitute the symbols) enable a certain amount of errors when reading and determining the respective cell values.

According to examples of the presently disclosed subject matter, an image mask (which is to be used for generating a machine-readable matrix code overlay image) can be computed such that, when the image mask is superimposed on a base image (e.g., a specific or a generic base image), the resulting machine-readable matrix code overlay image would include certain errors which can be corrected using redundant data (e.g., error correction data) that is included in the overlay image. Thus, according to examples of the presently disclosed subject matter, when a reader apparatus reads and decodes the machine-readable matrix code overlay image that was generated with the image mask, the errors in the overlay image can be corrected using the included redundant data, and the matrix code with the included errors can thus be considered as valid and machine-readable matrix code.

Further by way of examples of the presently disclosed subject matter, the image mask can include digital image elements, and the color, translucency property and/or shape of the digital image elements or of a group of digital image elements can be computed, such that a reader apparatus would be capable of reading and decoding the machine-readable matrix code overlay image that was generated with the image mask, and the errors in the overlay image, resulting from a certain color and/or translucency property and/or a shape of the digital image elements or of a group of digital image elements would be corrected using the included redundant data, and the matrix code with the included errors can thus be considered to be valid and machine-readable matrix code.

Throughout the description and the claims, reference is made to the terms “imager device” (or “imager” in short), “decoding device” (or “decoder” in short), “matrix code reader” (or “reader” in short), “matrix code scanner” (or “scanner” in short) and “equipment” which is used to refer to any one of the aforementioned devices or to a device which includes any combination of two or more of the aforementioned devices. The terms decoding device, matrix code reader and matrix code scanner are known in the art of optical machine-readable decoding, and the following definition is provided as a non-limiting example only for convenience purposes. Accordingly, interpretation of the terms decoding device, matrix code reader and matrix code scanner in the claims, unless stated otherwise, is not limited to the definitions below and the terms should be given their broadest reasonable interpretations. The terms decoding device, matrix code reader and matrix code scanner as used herein relate to an electronic device which is used in the process of detecting, imaging, scanning and/or decoding of a an image which represents a matrix code. It would be appreciated that such devices can be configured to operate according to one or more machine-readable matrix code specifications. As described above, according to examples of the presently disclosed subject matter, given equipment can include various features and/or capabilities and/or configurations that can have an effect on the matrix code values that are assigned to areas of an image (e.g., an overlay image) which correspond to different matrix code cells. By this effect, an image mask, which would yield an overlay image in which some areas do not “appear” to be compatible to a corresponding machine-readable matrix code specification, would still provide a valid machine-readable matrix code overlay image, since the “invalid” areas can be “turned” into “valid” values by the effects of the equipment.

Thus, according to examples of the presently disclosed subject matter, a machine-readable matrix code can be generated based on the machine-readable matrix code specification and also based on the characteristics and/or configurations of the reading and processing hardware and software which can be used to scan, read and/or decode various images that represent matrix codes that include various variations relative to the machine-readable matrix code specification, and such devices (hardware or software) either by design or as a side effect of their characteristics and/or configurations can render the image into a machine-readable matrix code that is compatible with a machine-readable matrix code specification. Likewise, according to examples of the presently disclosed subject matter, an image mask that is computed so as to provide a machine-readable matrix code overlay image (together with a specific or with a generic base image), can be based on the machine-readable matrix code specification and also based on the characteristics and/or configurations of the reading and processing hardware and software which can be used to scan, read and/or decode the overlay image that includes various variations relative to the machine-readable matrix code specification, and such devices (hardware or software) either by design or as a side effect of their characteristics and/or configurations can render the overlay image into a machine-readable matrix code that is compatible with a machine-readable matrix code specification.

In this regard, as mentioned above, it would be appreciated that the image mask or the method or device for generating an image mask according to examples of the presently disclosed subject matter, can be tuned or configured according to the characteristics of equipment or software modules that are used in the imaging or processing of the overlay image generated using the image mask or it can even be configured according to a general characteristic or configuration of such equipment of software. It would be appreciated, that according to examples of the presently disclosed subject matter, a representation in an image of a matrix code should be considered as a machine-readable matrix code according to a corresponding machine-readable matrix code specification, when taking into account the characteristics and/or the configuration of the equipment and/or software and the various features and tolerances in the machine-readable matrix code specification which allow some extent of flexibility with respect to the values of the different properties of the matrix code cells and the corresponding flexibility with respect to the color, translucency and/or shape of digital image elements in an image mask that is used for generating the machine-readable matrix code overlay image.

Throughout the description and the claims, reference is made to the term “input image”. The term input image as used herein relates to a digital representation of a two-dimensional figure, such as a painting, photograph, map, chart, drawing or print, which is used as some reference in the process of generating an image mask, according to examples of the presently disclosed subject matter. According to examples of the presently disclosed subject matter, the input image can be the base image which is overlaid by the mask image to provide the machine-readable matrix code overlay image. For example, the dimensions of the input image may be required to be in compliance with the requirement set forth in the machine-readable matrix coding specification.

It would be appreciated that the matrix coding specification can support a variety of different sizes and dimensions and the image mask, the base image and the overlay image can have dimensions which match any one of the supported dimensions. Further, the dimensions of the image mask, the base image and/or the overlay image can be different from any of the preferred dimensions which are set forth in the machine-readable matrix code specification. For example, in such cases where the image mask, the base image and/or the overlay image dimensions are different from any of the preferred dimensions which are set forth in the machine-readable matrix code specification, the image mask, the base image and/or the overlay image can be re-sampled to fit the preferred dimensions. Furthermore, even without such re-sampling, in some examples of the presently disclosed subject matter, the tolerance presented by the machine-readable matrix code specification and the imaging and/or reading process performed by equipment or software can be taken advantage of. For example, the cells' dimensions tolerance can be exploited by altering the specification's suggested dimensions of few cells, such that the final matrix code dimensions will fit to the image mask, the base image and/or the overlay image one.

It would also be appreciated that some machine-readable matrix code specifications can require or suggest that cells, modules and/or digital image elements of the image mask, the base image and/or the overlay image be of an integer width and/or height, while the tolerance presented by the matrix code specification and the reading process performed by the equipment or software can enable the creation of a machine-readable matrix code with non-integer cells' measures, for instance by sharing a certain border pixel between two cells, or re-sampling the matrix code. In addition, according to examples of the presently disclosed subject matter, an original image can undergo preprocessing before being fed to the process or device according to examples of the presently disclosed subject matter, whereby, for example, the input image can be re-sampled and its dimensions can be adjusted according to at least one of the dimensions that are supported or suggested by a machine-readable matrix code specification.

According to examples of the presently disclosed subject matter the overlay image can be provided as part of a larger image, and the base image can correspond to the part of the image taken by the overlay image. This part of the image can be used when computing the image mask, according to examples of the presently disclosed subject matter.

It should also be appreciated, that any of the images mentioned here can be in any form or format which can be converted to a digital visual representation, e.g., a digital image or a file which represents a digital image, or can be in the form of digital data stored in a tangible computer readable storage medium. Examples of types of visual representations can include: prints, digital images, impressions, holograms, text, text representation of images, etc.

Throughout the description and the claims, reference is made to the term “function patterns”, “function modules” or “function cells” which are used herein interchangeably. The terms function pattern, function module or function cells, are known in the art of optical coding, and the following definition is provided as a non-limiting example only for convenience purposes. Accordingly, interpretation of the term function pattern, function module or functions cell in the claims, unless stated otherwise, is not limited to the definitions below and should be given its broadest reasonable interpretation. Function pattern, function module or function cell as used herein relate to a group of matrix code cells that are defined in a corresponding machine-readable matrix code specification and which serve a predefined ancillary function which can be used in the imaging, scanning and/or decoding process of the message that is encoded in the machine-readable matrix code. For example, function patterns can be used for indicating the location of the machine-readable matrix code or to specify certain characteristics of the machine-readable matrix code. For example the QR-Code specification includes provisions for the following function patterns: finder, separator, timing patterns, and alignment patterns.

Throughout the description and the claims, reference is made to the term “encoding region”. The term encoding region is known in the art of optical coding, and the following definition is provided as a non-limiting example only for convenience purposes. Accordingly, interpretation of the term encoding region in the claims, unless stated otherwise, is not limited to the definitions below and should be given its broadest reasonable interpretation. The term encoding region as used herein relates to a region of the machine-readable matrix code that is not occupied by function patterns and is available for encoding of data and error correction code-words, and for metadata cells, which provide necessary or optional information about the format, version and other characteristics of the encoded data.

Throughout the description and the claims, reference is made to the term “code-word” or “code-words”. The terms code-word or code-words are known in the art of optical coding, and the following definition is provided as a non-limiting example only for convenience purposes. Accordingly, interpretation of the term code-words in the claims, unless stated otherwise, is not limited to the definitions below and should be given its broadest reasonable interpretation. The term code-words as used herein relates to a bit stream that is used in a machine-readable matrix code to structure a code message into words. A machine-readable matrix code specification usually suggests (or requires) a certain structure for the code-words or enables a selection of one of a plurality of predefined structures. For example, in the QR-Code specification a word is usually defined by an 8-bit array. A code-words can structure a data bit stream, an error correction bit stream, both data and error correction bit streams and can include metadata.

The final code-words are usually comprised of a set of code-words and possibly some metadata that are to be encoded in the encoding region of the machine-readable matrix code. By way of example the final code-words can include data code-words, error correction code-words, and metadata.

Throughout the description and the claims, reference is made to the term “free cells”. The term free cells as used herein relates to code-word cells (cells which are included in the code-words), and more specifically to the code-word cells that can receive any valid value according to the machine-readable matrix code specification. According to examples of the presently disclosed subject matter, the values computed for at least some areas in the image mask which correspond to areas which represent free cells in the overlay image can be calculated according to an appearance of respective areas in a reference image, e.g., areas of the base image.

It should be appreciated that for code-word cells, including for free cells, a general cell specification (which is part of the machine-readable matrix code specification) can define a valid value as either dark or light, i.e., the values for the code-word cells are binary. Furthermore, in some machine-readable matrix code specifications, the value of a cell can be modified in the decoding process, for example, by applying a decoding coding mask to the machine-readable matrix code during the decoding process. Accordingly, the values that are calculated for the different areas in the image mask which correspond to different cell types as part of the process of generating an image mask, according to examples of the presently disclosed subject matter, are based on, inter-alia, the values (e.g., the dark/light binary values) which are set forth by the machine-readable matrix code specification. It should be appreciated that in some machine-readable matrix code specifications, more than two valid values are defined.

As mentioned above, the general cell specification of the machine-readable matrix code specification can set forth a definition of a valid value. Such a value is termed herein a “decode input value”. By way of example a valid value for a cell according to the general cell specification is a binary value, i.e., the cell is required to be either dark or light. As mentioned above, the decode input value can be modified in the decoding process, for example, by a decoding mask that is applied to the machine-readable matrix code in the decoding process. In such cases, the value of interest for the process of generating an image mask, which in turn can be used for generating a machine-readable matrix code overlay image, according to examples of the presently disclosed subject matter, is the value at the input to the decoder, which is not necessarily the same as the value after decoding (e.g., due to use of the decoding mask in the decoding process). It would be also appreciated, that some decoders can implement pre-processing of the machine-readable matrix code overlay image and other operations which are intended to prepare the machine-readable matrix code for the actual decoding. The decode input values which are referred to herein, are the values which are received after such pre-processing, if it exists. It should be appreciated that in some machine-readable matrix code specifications, more than two valid values are defined. Therefore, for example, the decode input value may be of a ternary type (or of any other N values type).

Throughout the description and the claims, reference is made to the term “decode value”. The term decode value is known in the art of optical coding, and the following definition is provided as a non-limiting example only for convenience purposes. Accordingly, interpretation of the term decode value in the claims, unless stated otherwise, is not limited to the definitions below and should be given its broadest reasonable interpretation. A decode value is a value obtained from the decode input value using a decoding process mentioned above, if it exists. If a decoding process does not exist then the decode value equals to the decode input value. For example, a decode input value can be dark (e.g. 0), and after a XOR operation decoding mask is applied with a respective light value (e.g., 1), a decode value will be light (e.g., 1). This example illustrates a distinction between the term decode input value and the term decode value.

According to examples of the presently disclosed subject matter, the values that are calculated for some of the cells of the machine-readable matrix code can be color values and/or luminosity values. As will be described in further detail below, the process of generating an image mask, which is to be used for generating a machine-readable matrix code overlay image, according to examples of the presently disclosed subject matter, can be used to determine, for different areas of the image mask, which correspond to different cells of a machine-readable matrix code (e.g. for the pixel or pixels which represent the cells), the color and/or luminosity and/or translucency and/or shape properties that can be used to provide the desired target values of the respective cells and patterns in the machine-readable matrix code overlay image. As will also be described below, the process of generating an image mask according to examples of the presently disclosed subject matter can be configured to take into account certain characteristics, configurations and/or capabilities of the equipment or software that are used in the process of capturing and processing a representation of the machine-readable matrix code which was generated using the computed image mask, to expand the possible range of values which can be used for different areas of the image mask, beyond the range which would be required by the matrix code specification. Further by way of Illustration, according to examples of the presently disclosed subject matter, the decode input values which are associated with the free cells are essentially a result of the process of generating an image mask and overlaying the image mask on a base image to provide a machine-readable matrix code overlay image.

Furthermore, according to examples of the presently disclosed subject matter, assuming that the decode input values which are required/suggested by the machine-readable matrix code specification define a first set of values, the color values and/or luminosity and/or transparency values of the shapes that are calculated for the areas which in the Image mask that correspond to cells in a machine-readable matrix code overlay image according to examples of the presently disclosed subject matter, define a second set of values which is larger than the first set, such that each value in the first set is associated with two or more (e.g., 2, 3, . . . , n) values in the second set (for one or more properties). It would be further appreciated that according to examples of the presently disclosed subject matter, the second set can include two or more (e.g., . . . , n) subsets and the values in the first set can be associated with one or more values in each subset of the second set. Thus, for example, a light/dark value from the first set can be associated with a plurality of color values and/or with a plurality of luminosity values and/or with a plurality of translucency values and/or with a plurality of shapes.

Returning now to the definition of the term “free cells” as it is used herein. According to examples of the presently disclosed subject matter, the values for the free cells are valid in the sense that they meet the general cell specification in the machine-readable matrix code specification at the decode start point. For example, the values for the free cells can be calculated based on the requirements and/or suggestions set forth in the general cell specification regarding the valid range of cell values, and for at least some of free cells, the decode input values can be calculated further based on the appearance of respective areas of a reference image (e.g., a base image) with which the machine-readable matrix code overlay image is associated. For example, a visual similarity criterion can be used in this calculation. Thus, the values for the free cells, can for example include color and/or luminosity values, which, at the decode start point, are translated to dark/light values which are valid according to the machine-readable matrix code, and the properties of various areas of the mask image can be computed accordingly. According to examples of the presently disclosed subject matter, calculating the decode input value as mentioned above dictates the decode value according to the decoding process.

In this regard, it would be appreciated that based on the machine-readable matrix code specification or based on user or otherwise defined configurations, the decoded input values of some of the areas or digital image elements of the image mask can be restricted or dependent according to restrictions and other constraints (in addition to those in the matrix code specification) related to the corresponding areas in the overlay image which correspond to free cells, and according to examples of the presently disclosed subject matter, such cells are not considered “free cells”. For example, free cells include only the code-word cells which are not restricted or dependent based on the machine-readable matrix code specification or based on user or otherwise defined configurations (not including the restrictions set forth in the general cell specification), and possibly also include padding cells, and possibly also include some border cells, for which the user or/and a selection based on a predefined criterion or rule are allowed to select the color and/or luminosity values as long as the selected values meet the general cell specification at the decode start point, and the respective areas of the image mask can be accordingly subject to such restricted range of values.

In the following description, for convenience and by way of example, free cells are sometimes referred to as being code-word cells of a machine-readable matrix code. In some examples of the presently disclosed subject matter, the free cells can also include padding cells and/or border cells which are suggested and/or required by the corresponding machine-readable matrix code specification. In other examples of the presently disclosed subject matter, padding/border cells are not considered free cells and different processing is applied to the free cells and to the padding cells, and accordingly, different rules and/or criteria are applied to the computation of respective areas of the image mask.

According to examples of the presently disclosed subject matter, the general cells specification that is included in the machine-readable matrix code specification can provide the suggestions or requirements with respect to the free cells. The general cells specification includes the basic rules which apply to substantially all the cells in the matrix code and provide the framework of the machine-readable matrix code. For example, the general cells specification can include a requirement that the color values of the cell will be selected from a first set of colors, which is, for example, a relatively small set. Further by way of example, the set of colors that is allowed or suggested according to the general cells specification can be smaller than the set of colors that is used in the process of generating a machine-readable matrix code, in particular for free cells. In some machine-readable matrix code specifications the suggested or required set of colors for machine-readable matrix code cells is binary and a decode input value needs to be either dark or light. By way of example, the general cells specification can suggest or require a certain limit with respect to the range of values that a free cell can receive. Accordingly, the free cells can be regarded as free in the sense that they can receive any value that is within the general framework.

As mentioned above, a machine-readable matrix code specification can include certain tolerances, which can be implemented as part of the process of generating an image mask according to examples of the presently disclosed subject matter. Further by way of example, the tolerances included in the machine-readable matrix code specification can be effective for increasing or decreasing the range of values that free cells can receive, and subsequently, the tolerances included in the machine-readable matrix code specification can affect the range of color and/or translucency values that can be used for corresponding areas of an image mask.

Furthermore, the limit on the range of data that can be encoded in the free cells can be associated with characteristics of a given scanner, reader or decoder or any combinations thereof, or even to a general characteristic of scanners, readers or decoders. For example, in the process of generating an image mask, the range of values that are allowed for free cells in an overlay image that is generated using the image mask and a base image, can be determined according to the machine-readable matrix code specification and further in accordance with a characteristic(s) of the scanner/reader/decoder. More specifically, in some examples of the presently disclosed subject matter, the range of allowed values for the free cells that is relayed upon in the process of generating the image mask can be adjusted (relative to what would have been compatible with the machine-readable matrix code specification) according to a characteristic(s) of the scanner/reader/decoder.

As would be appreciated, a machine-readable matrix code specification allocates a certain part of the machine-readable matrix code, and more specifically of the code-words, for free cells, which for example, allow a user (or some other input message source) to enter specific data that is to be encoded in the machine-readable matrix code. In still further examples, the machine-readable matrix code specification allocates a certain part of the code-words for derived cells. Further by way of example, in order to be valid (or machine-readable), the code-words of the matrix code need to include a certain extent of derived cells (e.g., error correction cells), as will be further described herein. In further examples, in addition to free cells and derived cells, the code-words of a machine-readable matrix code can also include selected cells, as further discussed herein.

Throughout the description and the claims, reference is made to the term “derived cells”. The term derived cells is known in the art of optical coding, and the following definition is provided as a non-limiting example only for convenience purposes. Accordingly, interpretation of the term derived cells in the claims, unless stated otherwise, is not limited to the definitions below and should be given its broadest reasonable interpretation. The term derived cells, as used herein, relates to cells which are part of a code-words and whose values are derived from the value of corresponding free cells and according to the machine-readable matrix code specification.

According to examples of the presently disclosed subject matter, derived cells can include error correction data which is derived from corresponding data that is encoded in corresponding free cells. However, in further examples of the presently disclosed subject matter, the derived cells can be the data cells, and the free cells can hold the error correction data. In yet further examples of the presently disclosed subject matter, some of the free cells hold data and other free cells hold error correction data and the derived cells hold error correction data which is associated with (and derived from) the data in the free cells and data that is associated with (and derived from) the error correction data in the free cells.

According to examples of the presently disclosed subject matter, for the areas of the image mask which correspond to derived cells, the color and/or translucency and/or shape of a given area can be calculated according to the decode input values of the free cells in the overlay image (resulting from superimposing the image mask over a specific or generic base image). Further by way of example, the calculation of the color and/or translucency and/or shape for the areas of the image which correspond to derived cells can also take into account a tolerance that is provided by the respective machine-readable matrix code specification. Still further by way of example, the calculation of the color and/or translucency and/or shape for the areas of the image mask which correspond to derived cells can also take into account a tolerance that is provided by the equipment and/or software that is used to image, process and decode the overlay image that was generated with the image mask. In yet further examples of the presently disclosed subject matter, additional criteria can be taken into account in the calculation of the color and/or translucency and/or shape for the areas of the image mask which correspond to derived cells, including for example a visual perceptual similarity to the respective areas of a reference image. Further by way of example, the reference image can be the base image.

For example, in QR-Code, the error correction method is based on Reed-Solomon coding. This method produces a systematic binary code which is a subset of a Binary Finite Field, hence it obeys the Binary Finite Field Arithmetic. Accordingly, a simple corresponding arithmetic technique, (such as Gauss-Jordan Elimination) can be used to control (and free) the error correction cells (or some of them) while relinquishing control of the data cells, which then become derived cells according to examples of the presently disclosed subject matter.

Whether the derived cells hold the data or the complementing error correction data, according to examples of the presently disclosed subject matter, the decoded values for the area in the image mask which correspond to derived cells are calculated based on the values of the areas in the image mask which correspond to free cells. As mentioned above, according to examples of the presently disclosed subject matter, the values that are calculated for the areas of the image mask which correspond to derived cells can be color and/or translucency and/or shape values. Further by way of example, the values for the areas that correspond to the derived cells can be calculated such that in addition to being associated with the values of the areas corresponding to the free cells, the values for the areas corresponding to the derived cells are associated with the values set forth in the general cell specification, such that at the decode start point of the overlay image generated with the image mask, the values for the derived cells are valid according to the machine-readable matrix code specification.

Throughout the description and the claims, reference is made to the term “metadata cells”. The term metadata cells is known in the art of optical coding, and the following definition is provided as a non-limiting example only for convenience purposes. Accordingly, interpretation of the term metadata cells in the claims, unless stated otherwise, is not limited to the definitions below and should be given its broadest reasonable interpretation. The term metadata cells, as used herein, relates to cells in the encoding region of a machine-readable matrix code which provide necessary or optional information about the format, version and other characteristics of the encoded data. By way of example, the QR-Code specification suggests to include format information cells and version cells, which provide information about cells or symbol characteristics and matrix code version. This information can be used for enabling decoding of the remainder of the encoding region.

According to examples of the presently disclosed subject matter, the values that are calculated for areas of the image mask which correspond to the metadata cells in the machine-readable matrix code overlay image can be color and/or translucency and/or shape values. Further by way of example, the values for areas of the image mask which correspond to the metadata cells can be calculated, such that the values of the metadata cells in the respective overlay image are compatible with the values set forth in the general cell specification, in addition to being associated with the metadata that needs to be encoded in the metadata cells, such that at the decode start point, the values for the derived cells are valid according to the machine-readable matrix code specification. Further according to examples of the presently disclosed subject matter, the values that are calculated for the areas in the image mask which correspond to metadata cells can also take into account the appearance of the respective areas in the reference image.

Throughout the description and the claims, reference is made to the term “selected cells”. The term selected cells, as used herein, relates to machine-readable matrix code cells which are selected from amongst the code-word cells, and the values for the selected cells are associated with a predefined message that is to be encoded in the selected cells.

According to examples of the presently disclosed subject matter, the selected cells can be a subset of the free cells, but unlike the free cells, the decode values for the selected cells are not based on the appearance of respective areas of the input image with which the machine-readable matrix code is associated. Still further according to examples of the presently disclosed subject matter, visual perceptual similarity can be disregarded when the decode values for the areas of the image mask which correspond to the selected cells are computed. However, in yet further examples of the presently disclosed subject matter, the computation of the color and/or translucency values and/or shape that for the areas of the image mask which correspond to selected cells can take into account the appearance of respective areas of the reference image, in addition to a predefined message that is to be encoded in the selected cells, and in addition to the general cell specification. For example, visual similarity among the readable matrix code overlay image and a reference image can be taken into account.

In examples of the presently disclosed subject matter, the values for the areas in the image mask which correspond to selected cells can be further based on the characteristics and/or configurations of the equipment and/or software that is used for imaging, processing and/or decoding the respective overlay image, such that the values that are assigned to the area of the image mask which correspond to selected cells are in compliance with the corresponding machine-readable matrix specification.

Throughout the description and the claims, reference is made to the terms “visual similarity”, “perceptual similarity”, “visual perceptual similarity” or the like. The terms “visual similarity”, “perceptual similarity” or the like are known in the art of optical coding, and the following definition is provided as a non-limiting example only for convenience purposes. Accordingly, interpretation of the term “visual similarity”, “perceptual similarity”, “visual perceptual similarity” or the like in the claims, unless stated otherwise, is not limited to the definitions below and the terms “visual similarity”, “perceptual similarity”, “visual perceptual similarity” or the like should be given their broadest reasonable interpretation. The terms visual similarity or perceptual similarity relate to a relationship between a reference image and a machine-readable matrix code overlay image resulting from the superimposing of an image mask over a base image, where the overlay image includes a matrix code, or to a relationship between a certain part of a reference image and a machine-readable matrix code overlay image.

According to examples of the presently disclosed subject matter, a relationship between the reference image or some part thereof and the machine-readable matrix code overlay image can be measured using one or more visual similarity measures. It would be appreciated that the process of generating an image mask according to examples of the presently disclosed subject matter can include an a-priori evaluation of a relationship between a machine-readable matrix code overlay image resulting from the superimposing of an image mask (or a candidate image mask) over a specific or over a generic base image. Such a-priori evaluation can be implemented as part of the computation of the color and/or luminosity value or the shape of the various areas of the mask image in order to provide, together with the respective areas of the base image, an overlay image that encodes an input message. According to examples of the presently disclosed subject matter, the a-priori evaluation can take into account the machine-readable matrix code specification and the base image. According to examples of the presently disclosed subject matter, the a-priori evaluation can take into account a reference image (in case it is not the same as the base image). In yet further examples of the presently disclosed subject matter, the a-priori evaluation can take into account the tolerances provided in the machine-readable matrix code specification. In still further examples of the presently disclosed subject matter, the a-priori evaluation can take into account the tolerances provided by the equipment and/or software that is used in the imaging, processing and decoding the machine-readable matrix code overlay image. In still further examples of the presently disclosed subject matter, the a-priori evaluation can take into account a visual similarity criterion (e.g., relative to a reference image).

Non-limiting examples of visual similarity measures is an L-norm distance between color values of the corresponding pixels within the reference and overlay image. Further by way of example A PSNR over MSE measure can be used between the intensity levels of the corresponding pixels in the reference and overlay image. Another example for such a perceptual similarity measure is an L-norm distance measured between edge descriptors of fitting salient areas in the overlay and reference image. Yet a further example of a perceptual similarity measure that can be used is the structural similarity index measure (SSIM), which incorporates loss of correlation, luminance distortion and contrast distortion measures. Moreover, additional computer vision techniques such as saliency detection, object detection, object recognition can be incorporated in such visual perception measures.

In some examples of the presently disclosed subject matter, threshold or criteria can be used as part of the process of calculating values for certain areas of the image mask (e.g. areas which correspond to free cells, derived cells, selected cells) and can set forth a certain level of similarity (e.g., a score) above which a respective cell in the overlay image would be considered to provide a target perceptual similarity to a corresponding area of a reference image. Such criteria or threshold can be used to achieve a sufficient level of perceptual similarity in the overlay image as part of an optimization function which searches for image mask values that would provide an overlay image that meets a perceptual similarity threshold or criterion possibly taking into account other goals, constraints or targets.

Throughout the description and the claims, reference is made to the term “template of a machine-readable matrix code”. The term template of a machine-readable matrix code as used herein relates to a definition of basic properties of different areas of an image mask in accordance with examples of the presently disclosed subject matter. According to examples of the presently disclosed subject matter, the different areas to which the template of a machine-readable matrix code relates are the different modules of a machine-readable matrix code which is associated with an overlay image that the Image mask is intended to provide (together with a base image). According to examples of the presently disclosed subject matter, the template of a machine-readable matrix code can provide a different definition for each one or of the following machine-readable matrix code modules (or at least to some of which): basic cell, function patterns, code-word cells, free cells, padding cells, derived cells, metadata cells, selected cells. It would be appreciated that according to examples of the presently disclosed subject matter, with respect to a certain point in the image mask more than one type of definition from the template of a machine-readable matrix code can apply, or the definition can be provided, such that some definitions include a more generic definition. For example, with respect to a certain point or area in the image mask, the template of a machine-readable matrix code can include the basic cell definition and the free cell definition, or in another example, the free cell definition can encapsulate the definitions of the basic cell.

According to examples of the presently disclosed subject matter, the definitions in the template of a machine-readable matrix code can relate to one or more of the following properties: color values or a range of color values, a transparency value or a range of transparency value and shape properties. According to further examples of the presently disclosed subject matter, the template of the machine-readable matrix code can relate to dimensions, ratio and/or scale of the machine-readable matrix code representation and/or to dimensions, ratio and/or relative location of an area corresponding to a cell, a group of cells and/or a pattern or module.

Reference is now made to FIG. 1, which is a block diagram illustration of an apparatus that is capable of generating an image mask, according to examples of the presently disclosed subject matter. According to examples of the presently disclosed subject matter, the apparatus for generating an image mask 100 can include: a controller 20, a memory unit 30, a configurator 40 and an image processing module 50. By way of example, the apparatus 100 can also include an input interface 10 and an output interface 60.

It would be appreciated that in some examples of the presently disclosed subject matter, the apparatus can include more or fewer components. For example, in some examples of the presently disclosed subject matter, the image processing module 50 can be implemented using data and logic that can be stored in the memory unit 30, and executed on the processing unit 20. The configurator 40 can also be implemented as data and logic that can be stored in the memory unit 30, and executed on the processing unit 20.

Reference is now additionally made to FIG. 2, which is a flowchart illustration of a method of generating an image mask, according to examples of the presently disclosed subject matter. According to examples of the presently disclosed subject matter, as part of a method of generating an image mask, certain input data may be obtained. The input data may be pre-stored in the apparatus' memory 30 or it can be obtained from an external source, e.g., through the input interface 10, for a specific execution cycle of the process of generating the image mask (or for several cycles of the process).

According to examples of the presently disclosed subject matter, the input data can include an input message or a machine-readable matrix code representation encoding an input message (block 205), a template of a machine-readable matrix code (block 210), and a machine-readable matrix code specification (block 215). According to some examples of the presently disclosed subject matter, an input image can also be obtained (block 202).

According to examples of the presently disclosed subject matter, the input message or the machine-readable matrix code representation can be provided as input to apparatus 100, e.g., through the input interface 10. For example, the input message or the machine-readable matrix code representation encoding an input message can be uploaded into the apparatus 100 from a remote computerized device. In another example, the input message is entered by an operator of the apparatus 100 by use of the interface 10.

According to examples of the presently disclosed subject matter, the template of the machine-readable matrix code can be pre-stored, e.g., in the memory unit 30. According to further examples of the presently disclosed subject matter, the template of the machine-readable matrix code can be generated from the machine-readable matrix code specification. In this example, the controller 20 and a machine-readable matrix code specification module 44, that is implemented in the configurator 40, can be used to generate the machine-readable matrix code template.

In further examples of the presently disclosed subject matter, the template of the machine-readable matrix code can be generated from the input machine-readable matrix code representation which encodes the input message. For example, the input machine-readable matrix code representation can be processed to determine with which machine-readable matrix code specification type it is associated and the template of the machine-readable matrix code template can be generated according to the identified type. In further examples of the presently disclosed subject matter, the input machine-readable matrix code representation can be processed and the template of the machine-readable matrix code can be adapted or configured according to certain characteristics or properties of the input machine-readable matrix code representation. By way of example, the controller 20 and/or the image processing module 50 can be used. Still further by way of example, the image processing module 50 can include a machine-readable matrix code decoder (or multiple decoders) 56, and can use the decoder to process the input machine-readable matrix code representation for generating the template of the machine-readable matrix code.

According to examples of the presently disclosed subject matter, the input message can be provided as an alphanumeric string, as a digital code representing an alphanumeric string, or in any other form. Still further by way of example, in case an input message is provided (rather a machine-readable matrix code representation of an input message), the input message can be memorized in the memory unit 30, and the controller 20 can be configured to generate a machine-readable matrix code representation of the input message that is to be used for generating the image mask. Still further by way of example, the controller 20 can use the configurator 40 and the machine-readable matrix code specification definition provided by machine-readable matrix code specification module 44 to generate the machine-readable matrix code representation of the input message, and possibly the controller 20 can be configured to utilize to this end the image processing module 50.

It would be appreciated, that according to examples of the presently disclosed subject matter, multiple machine-readable matrix types can be supported and multiple of selected image masks can be generated according to the supported machine-readable matrix types, and possibly according to the data that is provided as input. For example, upon receiving an input, a process can be implemented to identify the machine-readable matrix code with which the input is associated, which can either be explicitly specified in the input data, or it can be determined through processing of the input data, e.g., by processing an input machine-readable matrix code and identifying the machine-readable matrix specification with which it is compatible.

Resuming now the description of the method generating an Image mask shown in FIG. 2, a plurality of digital image elements can be initialized according to the machine-readable matrix code and based on a template of a machine-readable matrix code (block 220). Digital image elements associated with function patterns are initialized in the position of the function patterns covering the areas of the function patterns or at least part of it. Digital image elements associated with encoding region cells (code-word cells) are initialized in the position of the encoding region cells covering the areas of the encoding regions cells or at least part of it. It would be appreciated that digital image elements can be positioned to cover an area which is larger, exactly the same, or smaller than the area of the associated cells or patterns. According to examples of the presently disclosed subject matter, the image mask format can be a raster graphics image format using square pixels as the digital image elements. Further by way of example, each pixel can be associated with one cell or with one pattern. For example, each encoding region cell can be associated solely with one pixel, and function patterns can be associated with a minimum amount of pixels needed in the exact position according to the machine-readable matrix code specification. According to additional examples of the presently disclosed subject matter, the image mask format can be a vector format using vectors as the digital image elements. Further by way of example, each vector can be associated with one cell or with one pattern. For example, each encoding region cell can be associated solely with an octagon vector, and function patterns can be a set of vectors capable of providing a machine-readable function pattern according to the machine-readable matrix code specification.

Next, a color property and/or a translucency property can be calculated for the plurality of digital image elements based on the input message or based on the input machine-readable matrix code representation and based on a machine-readable matrix code specification (block 225). According to examples of the presently disclosed subject matter, the color property and/or the translucency property can be calculated for the plurality of digital image elements further based on a property (e.g., a color value) of a corresponding area in an input image.

An image mask can be generated using the plurality of digital image elements for which the color property and/or the translucency property were computed (block 230).

According to examples of the presently disclosed subject matter, for each area of the image mask which corresponds to a cell or a pattern in an overlay image that is to be generated using the image mask, values in the alpha channel will determine the appearance of the cell in the overlay image. In further examples of the presently disclosed subject matter, for each area of the image mask which corresponds to a cell or a pattern in an overlay image that is to be generated using the image mask, values in the grey-level or color channel will determine the appearance of the cell in the overlay image. In yet further examples of the presently disclosed subject matter, for each area of the image mask which corresponds to a cell or a pattern in an overlay image that is to be generated using the Image mask, values in the alpha channel and the grey-level or color channel will determine the appearance of the cell in the overlay image.

For example, in case the process is implemented to provide an image mask that is to be used for generating a machine-readable matrix code overlay image which is compatible with the QR code specification, and the digital image elements are pixels, the implementation of block 225 can include generating from the input machine-readable matrix code representation (and based on the QR code specification) a grey-level channel representation and an alpha channel representation. By way of example, the alpha channel representation (or the translucency values) can be computed such that a predefined superimposing technique, such as linear combination, using the generated grey channel and alpha channel (i.e., the generated image mask) together with a base image, will provide an overlay image which is compatible with a certain matrix code specification, possibly taking into account some tolerances and characteristics of equipment and/or software that are involved in the Imaging and/or processing of an overlay image generated using the image mask (or which the process is configured with).

According to examples of the presently disclosed subject matter, different modules or cells having the same decode input value can be associated with digital image elements that have a different color property and/or a different translucency property with respect to each other. According to examples of the presently disclosed subject matter, a difference in the color property and/or a difference in the translucency property of the digital image elements which are associated with cells or modules that have the same decode input value can be a result of the different effect which the tolerances provided in the machine-readable matrix code specification have on a visual appearance of each cell or module, and the corresponding effect on the color property and/or on the translucency property of each respective digital image element. Further according to examples of the presently disclosed subject matter, a difference in the color property and/or a difference in the translucency property of the digital image elements which are associated with cells or modules that have the same decode input value can be a result of the different effect that the tolerances provided by the equipment or the software that is/are used in the imaging or processing of the overlay image generated using the image mask have on a visual appearance of each cell or module, and the corresponding effect on the color property and/or on the translucency property of each respective digital image element. Still further according to examples of the presently disclosed subject matter, a difference in the color property and/or a difference in the translucency property of the digital image elements which are associated with cells or modules that have the same decode input value can be a result of the different effect that the visual appearance of respective (different) areas of a base image have on a visual appearance of each cell or module, and the corresponding effect on the color property and/or on the translucency property of each respective digital image element.

According to examples of the presently disclosed subject matter, the method of generating the image mask can further include adapting a color property and/or a translucency property and/or a shape of the digital image element based on the decode input value associated with the digital image element and based on a visual transformation effect resulting from superimposing the digital image element on an image and taking into account a tolerance provided in a respective machine-readable matrix code specification. Further by way of example, adapting a color property and/or a translucency property and/or a shape of the digital image can include applying an optimization function which takes into account the decode input value associated with the digital image element and a mathematical expression which corresponds to the visual transformation effect resulting from superimposing the digital image element on an image and a tolerance value representing the tolerance provided in the machine-readable matrix code specification.

According to examples of the presently disclosed subject matter, the method of generating the image mask can further include adapting a color property and/or a translucency property and/or a shape of the digital image element based on a visual transformation effect resulting from superimposing the digital image element on a base image and taking into account a characteristic of equipment or software that is involved in the imaging or processing of the overlay image. Further by way of example, adapting a color property and/or a translucency property and/or a shape of the digital image element can include applying an optimization function which takes into account the decode input value associated with the digital image element and a mathematical expression which corresponds to the effect resulting from superimposing the digital image element on an image and a mathematical expression which represents a characteristic of equipment or software that is involved in the imaging or processing of the overlay image.

According to examples of the presently disclosed subject matter, such optimization function and/or mathematical expression that is used for adapting a color property and/or a translucency property and/or a shape of the digital image element can be configured to implement a visual similarity measure, and the computation can be carried out by a dedicated visual similarity module 54 or by the controller 20 (which can include a CPU, GPU or any other suitable processing unit(s)). According to examples of the presently disclosed subject matter, the operation of computing a color property and/or a translucency property for the digital image elements of the image mask, can involve evaluation, and possibly a multi-iterative evaluation, of a plurality of candidate color properties and/or of a plurality of translucency properties. For example, computing the color property and/or a translucency property of a digital image element can be based on a visual similarity evolution (using the visual similarity measure) among a certain area (or areas) of a readable matrix code overlay image (actual or simulated) that was generated using a current candidate image mask and a respective area of a reference image. The color property and/or a translucency property can be computed to obtain a high visual similarity among respective areas of the readable matrix code overlay image and a reference image.

In another example, the shape property of a digital image element can be computed based on a visual similarity among the readable matrix code overlay image and a reference image. The shape of a plurality of digital image elements can be computed so that a visual similarity value that is computed by applying a visual similarity measure to evaluate a visual similarity among the readable matrix code overlay image and a reference image indicates a high visual similarity, e.g., a maximal visual similarity, or a visual similarity that meets an optimization criterion. For example if a vector is associated with a cell that is to be superimposed on an area of the base image having a triangular shape, the vector can be of a triangular shape. According to examples of the presently disclosed subject matter, the mentioned shape can be selected from a pre-stored set of shapes or can be dynamically computed according to a set of mathematical rules. For example such rules can be applicable to provide a certain polygon using its angles (between some of its ribs) as the parameter(s) of the optimization function.

According to examples of the presently disclosed subject matter, the Image mask can be overlaid on a base image to provide a machine-readable matrix code overlay image. According to examples of the presently disclosed subject matter, various overlay methods can be used, some of which were mentioned hereinabove.

In further examples of the presently disclosed subject matter, the machine-readable matrix code overlay image can be provided as output, e.g., using an output interface or interface. For example, the machine-readable matrix code overlay image can be displayed on a digital display screen or screens, or in another example the machine-readable matrix code overlay image can be printed on paper.

For example, in FIG. 3, there is shown an example of an image mask 302 represented by a grey-level channel representation 304 and an alpha channel representation 306, calculated according to examples of the presently disclosed subject matter. In the example shown in FIG. 3, for each cell of the grey level channel representation 304 the values in the corresponding cell of the alpha channel representation 302 can determine the visibility of the cell formed by superimposing the optical machine-readable image mask on an image. For illustration purposes the alpha channel representation 302 and the grey level channel representation 304 were computed based on a completely white base image.

By way of example, in the alpha channel representation 306 it is shown that cells having the same decode input value are associated with digital image elements with a different transparency property. For example, a digital image element that is referenced with the numeral 309 (309′ is an enlarged view of the digital image element 309), which is associated with a cell of a timing pattern, is associated with a ‘dark’ decode input value. A second digital image element that is referenced with the numeral 308 (308′ is an enlarged view of the digital image element 308), which is associated with a code-word cell, is associated with the same ‘dark’ decode input value. However, the first digital image element 309 is associated with pixels having a transparency property set to alpha equals 204, while the second digital image element 308 is associated with pixels that have a transparency property that is set to alpha equals 51.

As mentioned above, different modules or cells having the same decode input value, can be associated with digital image elements that have a different color property and/or a different translucency property with respect to each other, such as the first digital image element 309 and the second digital image element 308 in FIG. 3. As was also mentioned above, the difference in the color property and/or a difference in the translucency property of the digital image elements which are associated with cells or modules that have the same decode input value can be a result of the different effect which the tolerances provided in the machine-readable matrix code specification have on a visual appearance of each cell or module, and the corresponding effect on the color property and/or on the translucency property of each respective digital image element. Further according to examples of the presently disclosed subject matter, the difference in the color property and/or a difference in the translucency property of the digital image elements which are associated with cells or modules that have the same decode input value can be a result of the different effect that the tolerances provided by the equipment or the software that is/are used in the imaging or processing of the overlay image generated using the image mask have on a visual appearance of each cell or module, and the corresponding effect on the color property and/or on the translucency property of each respective digital image element. Still further according to examples of the presently disclosed subject matter, a difference in the color property and/or a difference in the translucency property of the digital image elements which are associated with cells or modules that have the same decode input value can be a result of the different effect that the visual appearance of respective (different) areas of a base image have on a visual appearance of each cell or module, and the corresponding effect on the color property and/or on the translucency property of each respective digital image element. As was also mentioned above, the method of generating the image mask can further include adapting a color property and/or a translucency property and/or a shape of the digital image element based on the decode input value associated with the digital image element and based on a visual transformation effect resulting from superimposing the digital image element on an image and taking into account the aforementioned factors which can affect the appearance of the resulting readable matrix code overlay image.

According to examples of the presently disclosed subject matter, the color property and/or a translucency property for the plurality of digital image elements can be computed further based on a probability expression, which represents a certain estimated probability that a machine-readable matrix code image, generated using the image mask could be successfully imaged and processed, such that the message encoded in the overlay image, by overlaying the image mask with the plurality of image elements for which the color property and/or a translucency property were computed as described herein, would be correctly decoded. In further examples of the presently disclosed subject matter, the probability expression can be configured according to a specific base image or in further examples the probability expression can be configured according to a generic (non-specific) model of a base image. In yet further examples, the probability expression can be configured according to certain equipment and/or software characteristics and/or according to certain environmental or ambient characteristics.

For example, in view of the above, the probability expression can be intended to provide an image mask, which can be overlaid on a base image (specific or generic), and under various known (and account for in the process) and unknown conditions (which are not accounted for) a successful decoding of an input message from an overlay image that was generated with the image mask. Further by way of example, the probability expression can be intended to provide an image mask which meets a certain visual appearance while meeting this successful decoding condition. It would be appreciated that using the probability expression can allow a certain level of freedom with regard to the appearance of the overlay image, and also with regard to the image mask or with regard to components or layers or the image mask (such as the grey-level/color channel and/or the alpha channel of the image mask).

According to examples of the presently disclosed subject matter, the calculation of the color property and/or the translucency property for the plurality of digital image elements, and the generation of the image mask can be carried out by the image processing module 50, and in a particular example, by an image mask processing module 52. Further by way of example, the image mask can be stored or memorized in the memory 30. Other temporary structures and variables, such as channels matrices can be stored in the memory 30. The machine-readable matrix code overlay image generated with the computed image mask, can be provided as output via the output interface 60 (e.g., displayed on a display).

FIG. 4 to which reference is now made, is a graphical illustration of the images and other data involved in a method of generating an image mask according to examples of the presently disclosed subject matter. As is shown in FIG. 4, an image mask 420 is computed 415, based on some input message 405 and based on an input image 410. In this case the image mask computation takes into account a specific image 410, rather than using a generic image (e.g., an all white image).

The image mask 420 can be overlaid on a base image 425, which is in this example the same as the input image 410 that was used to compute the image mask 420, to provide a machine-readable matrix code overlay image 430.

According to examples of the presently disclosed subject matter, the image mask and the corresponding overlay image can be associated with a certain area (or any other portion) of the input image. For example, the input image can be provided with positioning parameters (e.g., pixel coordinates). The positioning parameters can imply computation of an image mask which correspond to or that is based on a certain area of the input image, or the positioning parameters can also imply computation of an image mask which corresponds to the entire input image. By way of non-limiting example, a first input interface (a mouse or a keyboard) can be used to provide the positioning parameters, while the input image can be input by a second input device. In another example, an automatic or semi-automatic process can be implemented to suggest positioning parameters and/or an input image.

Further by way example, the positioning parameters can be determined by a: (a) random process, (b) according predefined such as the center of the image, or (c) by searching for a position which matches a predefined criterion. The criterion, which can be used for selecting the area of an input image that is to be used for computing the image mask according to examples of the presently disclosed subject matter, and for generating on overlay image whose location in the image corresponds to the positioning parameters, can involve searching for an area in the input image which is associated with a highest correlation to a machine-readable matrix code representation of an input message or of a matrix code representing an input message. This position can be computed by the visual similarity module 56. As mentioned above, various tolerances can be taken into account in the criterion that is used in the selection of the positioning parameters, including tolerance provided by a respective matrix code specification and/or tolerance which are associated with certain equipment and/or software characteristics and/or with certain environmental or ambient characteristics.

According to examples of the presently disclosed subject matter, any suitable technique for superimposing the optical machine-readable image mask with the image can be used. For example, the superimposition can be a translucent linear combination of the image mask and a base image, in accordance with the values of the alpha channel of the image mask. As another example, cells or areas or image elements in the image mask having specific colors can be made transparent or superimposed differently than others using a designated apparatus or software.

Reference is now made to FIGS. SA-C, which are graphical illustrations of various implementations of the method of generating an image mask according to examples of the presently disclosed subject matter. More particularly, in FIG. 5A there is shown a graphical illustration of an image mask 504 that was computed based on an entire input image 502, and a machine-readable matrix code overlay image 510 which is a result of superimposing the image mask over the entire input image 502, according to examples of the presently disclosed subject matter. In FIG. 5B, an image mask 514 is computed based on a specified area of the input image from FIG. SA, and the machine-readable matrix code overlay image 520 which is a result of superimposing the image mask 514 over the specified area of the input image 502, according to examples of the presently disclosed subject matter. In FIG. 5C, there is shown an image mask 524 that is generated based on a generic image (e.g., an entirely white image), and two examples of different machine-readable matrix code overlay images 530 and 540 that are generated using the image mask, according to examples of the presently disclosed subject matter.

In FIG. 5C, and in accordance with examples of the presently disclosed subject matter, the input image 502 is not involved in the process of generating the image mask 524, and instead a generic image is used. Further by way of example, the image mask 524 is generated to provide a machine-readable matrix code overlay image, when it is overlaid over any image. Thus, for example, a generic image that is used in the process of generating an image mask can represent a “worst case” scenario, or can represent a theoretical base image which imposes restrictive or a limited set of possible values for the different areas or image elements in the image mask. As is shown in FIG. 5C, the image mask that is generated using the generic image can be overlaid over various different images to provide different resulting overlay images, such as image 530 and 540, which are or which include a machine-readable matrix code representation. In the case of the machine-readable matrix code overlay image 530, the base image is the entire input image 502, and the entire overlay image 530 provides the machine-readable matrix code, whereas in the case of machine-readable matrix code overlay image 540, the base image is a portion of the input image 502, and a corresponding portion of the overlay image 540 provides the machine-readable matrix code. It would be noted that in each one of FIGS. 5A-5C a different image mask is provided, based on the respective implementation of the method of generating an image mask. It would also be noted that as is shown in FIGS. 5A and 5B versus FIG. 5C and according to examples of the presently disclosed subject matter, in case a specific reference image is used to compute the image mask (rather than using a generic non-specific reference image), the translucency properties, such as the alpha channel values, computed for the image mask can be relatively more transparent relative to the values which would have been computed without considering the specific properties of the reference image (as can be the case where the reference image is non-specific, e.g. an all white image or an all dark image). In case color values are computed for the image mask, more freedom with respect to the color values can be applied when a specific reference image is used to compute the image mask relatively to a case where a generic non-specific reference image is used.

As mentioned above, according to examples of the presently disclosed subject matter, the digital image elements for which the color and/or translucency properties can be computed, can be pixels. In a further example of the presently disclosed subject matter, the image elements for which the color and/or translucency properties can be computed, can be image vectors. For example, a vector representation such as the Scalable Vector Graphics open standard can be used. The Scalable Vector Graphics (SVG) is a family of specifications of an XML-based file format for two-dimensional vector graphics, both static and dynamic (i.e., interactive or animated). Another example of an image element can be associated with the EPS file format that can in some cases contain vector or/and bitmap representations. EPS is a DSC-conforming PostScript document with additional restrictions which is intended to be usable as a graphics file format. In other words, EPS files are intended to be self-contained, predictable PostScript documents that describe an image or drawing and can be placed within another PostScript document.

In further examples of the presently disclosed subject matter, the image mask can be provided as a layer in a multi-layer video stream. By way of example, the image mask can be provided as part of a multi-layer video frame, which, by incorporating the image mask layer, can provide a machine-readable matrix code. The image mask can be generated taking into account visual data which corresponds to a portion of the frame area, or in a further example, an image mask can be generated taking into account visual data which corresponds to the entire area of the frame. In yet a further example, the image mask is generated using a generic reference image or a generic reference frame.

Further by way of example, the image mask can be computed taking into account the color properties of different areas in a video frame. Still further by way of example, the input image and/or the reference image and the base image can be a frame of a video stream. It would be appreciated that the hereinabove mentioned video can be an animated image, such as animated GIF.

It will also be understood that the system according to the invention may be a suitably programmed computer. Likewise, the invention contemplates a computer program being machine-readable by a computer for executing the method of the invention. The invention further contemplates a machine-readable memory tangibly embodying a program of instructions executable by the machine for executing the method of the invention.

1. A method of generating a machine-readable matrix code image mask, comprising:
obtaining a message;
initializing a plurality of digital image elements based on a template of a machine-readable matrix code, wherein each digital image element is associated with one or more machine-readable matrix code cells; and
computing a color property and a translucency property for each one of the plurality of digital image elements based on the message and based on a machine-readable matrix code specification, wherein at least two cells having an identical decode input value are associated with respective digital image elements, and wherein the digital image elements with which each one of the at least two cells is associated have a different color property and/or a different translucency property relative to the color property and/or the translucency property of the digital image elements that are associated with the other cells from said at least two cells; and
generating a machine-readable matrix code mask using the plurality of digital image elements.

2. The method according to claim 1, further comprising superimposing the machine-readable matrix code image mask on a base image, giving rise to a machine-readable matrix code overlay image encoding the message.

3. The method according to claim 1, wherein said message is in a form of a machine-readable matrix code or in a form of a machine-readable matrix code mask.

4. The method according to claim 1, wherein the plurality of image elements are pixels.

5. The method according to claim 1, wherein the plurality of image elements are vectors.

6. The method according to claim 1, wherein said computing includes computing also a shape property for a plurality of digital image elements.

7. The method according to claim 1, wherein the machine-readable matrix code image mask is provided as a layer in a multi-layered video stream.

8. The method according to claim 1, wherein said computing a color property and a translucency property comprises: computing a color property and/or a translucency property for each one of the plurality of digital image elements based on the decode input value of a machine-readable matrix code cell with which the digital image element is associated and based on a visual transformation effect resulting from superimposing the digital image element on a base image and taking into account a tolerance provided in a machine-readable matrix code specification.

9. The method according to claim 8, further comprising adapting a color property and/or a translucency property of a digital image element based on decode input values of one or more other digital image elements.

10. The method according to claim 8, further comprising adapting a color property and/or a translucency property of a digital image element based on a visual transformation effect resulting from superimposing one or more other digital image elements over respective areas of a base image.

11. The method according to claim 1, further obtaining an input image and wherein said computing a color property and a translucency property comprises:
computing the color property and/or a translucency property for each one of the plurality of digital image elements based on a visual transformation effect resulting from superimposing the digital image elements on the input image and taking into account a visual similarity measure among the readable matrix code overlay image and the input image.

12. The method according to any one of claim 10 or claim 11, wherein the input image is a video frame from a plurality of video frames, and wherein at least said computing and generating is repeated for each video frame from the plurality of video frames.

13. The method according to any one of claim 10 or claim 11, wherein the input image is a single image from a set of images which together are an animated image, and wherein at least said computing and generating is repeated for each image from the plurality of the images.

14. A machine-readable matrix code mask encoding a message, comprising:
a plurality of digital image elements associated with function patterns of a machine-readable matrix code; and
a plurality of digital image elements associated with code-words cells of machine-readable matrix code,
wherein the decode input values for the cells are based on the message and based on a machine-readable matrix code specification, and
wherein each one of the plurality of digital image elements has a color property and a translucency property, and at least two cells having the same decode input values are associated with digital image elements having different color property and/or translucency property, such that when the machine-readable matrix code mask is superimposed on an image, a machine-readable matrix code image is generated.

15. The machine-readable matrix code mask according to claim 14, wherein the plurality of image elements are pixels.

16. The machine-readable matrix code mask according to claim 14, wherein the plurality of image elements are vectors.

17. The machine-readable matrix code mask according to claim 14, wherein each one of the plurality of digital image elements has a shape.

18. The machine-readable matrix code mask according to claim 14, wherein the plurality of digital image elements that are associated with code-word cells in the machine-readable matrix code image include one or more groups of digital image elements, wherein each group of digital image elements includes two or more digital image elements, and wherein each one of the two or more digital image elements in a group of digital image elements have a color property and/or a translucency property which provides, together with other digital image elements in the group, a decode input value for a cell with which the group of image elements is associated, such that the decode input value for the cell is compatible with the machine-readable matrix code specification.

19. The machine-readable matrix code according to claim 18, wherein the color property and/or a translucency property of each digital image element in a group of digital image elements is computed, taking into account a visual transformation effect resulting from superimposing the digital image elements in the group of digital image elements on a base image, and taking into account a tolerance provided in the machine-readable matrix code specification.

20. An apparatus for generating a machine-readable matrix code image mask, comprising:
a memory unit storing a message;
a configurator that is adapted to initialize a plurality of digital image elements based on a template of a machine-readable matrix code, wherein each digital image element is associated with one or more machine-readable matrix code cells;
an image processing module configured to compute a color property and a translucency property for each one of the plurality of digital image elements based on the message and based on a machine-readable matrix code specification, such that for at least two cells having an identical decode input value, the digital image elements with which each one of the at least two cells is associated have a different color property and/or a different translucency property relative to the color property and/or the translucency property of the digital image elements that are associated with the other cells from said at least two cells, and
wherein the image processing module is configured to generate a machine-readable matrix code mask using the plurality of digital image elements.

21. The apparatus according to claim 20, wherein the image processing module is further configured to superimpose the machine-readable matrix code image mask on a base image, giving rise to a machine-readable matrix code overlay image encoding the message.

22. The apparatus according to claim 20, wherein said message is in a form of a machine-readable matrix code or in a form of a machine-readable matrix code mask.

23. The apparatus according to claim 20, wherein the plurality of Image elements are pixels.

24. The apparatus according to claim 20, wherein the plurality of image elements are vectors.

25. The apparatus according to claim 20, wherein said image processing module is further configured to compute a shape in addition to computing a color property and a translucency property for each one of the plurality of digital image elements based on the message and based on a machine-readable matrix code specification.

26. The apparatus according to claim 20, wherein the machine-readable matrix code image mask is provided as a layer in a multi-layered video stream.

27. The apparatus according to claim 20, wherein said image processing module is configured to compute a color property and/or a translucency property for each one of the plurality of digital image elements based on the decode input value of a machine-readable matrix code cell with which the digital image element is associated and based on a visual transformation effect resulting from superimposing the digital image element on a base image and taking into account a tolerance provided in a machine-readable matrix code specification.

28. The apparatus according to claim 27, wherein said image processing module is configured to adapt a color property and/or a translucency property of a digital image element based on decode input values of one or more other digital image elements.

29. The apparatus according to claim 27, wherein said image processing module is configured to adapt a color property and/or a translucency property of a digital image element based on a visual transformation effect resulting from superimposing one or more other digital image elements over respective areas of a base image.

30. The apparatus according to claim 20, wherein the memory is further configured to store an input image and wherein the image processing module is configured to compute the color property and the translucency property for each one of the plurality of digital image elements based on a visual transformation effect resulting from superimposing the digital image elements over the input image and taking into account a visual similarity measure among the readable matrix code overlay image and the input image.

31. The apparatus according to any one of claim 29 or claim 30, wherein the input image is a video frame from a plurality of video frames, and wherein the image processing module is configured to compute a machine-readable matrix code mask for each video frame from the plurality of video frames.

32. The apparatus according to any one of claim 29 or claim 30, wherein the input image is a single image from a set of images which together form an animated image, and wherein the image processing module is configured to compute a machine-readable matrix code mask for each image from the plurality of the images.
